(19) United States
(12) Patent Application Publication
(10) Pub. No.: US 2026/0286988 A1
(43) Pub. Date: Sep. 24, 2026

(54) Hydraulic circuit with drive-connected valve and associated pump

(71) Applicant: EXEL INDUSTRIES, EPERNAY (FR)

(72) Inventors: Nicolas PLANTARD, EPERNAY (FR); Boussif KHALDI, EPERNAY (FR); Amadou DIALLO, EPERNAY (FR)

(21) Appl. No.: 19/560,780

(22) Filed: Mar. 9, 2026

(30) Foreign Application Priority Data
Mar. 20, 2025 (FR) 2502881

(51) Int. Cl. F15B 15/18; F15B 13/04

(52) U.S. Cl. CPC F15B 15/18; F15B 13/04

(57) ABSTRACT

A hydraulic circuit of a hydraulic pump with air motor, the hydraulic circuit including a circuit section containing a fluid. The hydraulic circuit includes a valve chamber and a valve arranged in the valve chamber and translationally movable in the valve chamber between an operating position and a relief position. The valve separates the valve chamber into a first sub-chamber and a second sub-chamber, the volumes of which vary as a function of movement of the valve, the valve being translated as a function of pressure at a first inlet of the first sub-chamber and pressure at a second inlet of the second sub-chamber.

### CROSS-REFERENCE TO RELATED APPLICATION

This application is a U.S. non-provisional application claiming the benefit of French Application No. 25 02881, filed on Mar. 20, 2025, which is incorporated herein by reference in its entirety.

### TECHNICAL FIELD OF THE INVENTION

The present invention relates to a hydraulic circuit of a hydraulic pump with an air motor, the hydraulic circuit including a circuit section, the circuit section containing a fluid, more particularly oil, the hydraulic circuit being adapted so that the fluid in the circuit section is driven by the air motor of the hydraulic pump, the hydraulic circuit including a valve chamber and a valve, the valve being arranged in the valve chamber, the valve being movable in translation in the valve chamber between an operating position and a relief position.

The present invention further relates to an associated pump.

### BACKGROUND OF THE INVENTION

Such a pump is used, for example, to supply coating product to a coating product spraying device.

When spraying is stopped, for example when the trigger on the gun of the coating product spraying device is released, there is a risk of temporary overpressure in the high-pressure section of the hydraulic circuitry.

In a hydraulic circuit, a valve is used to protect the pump in the event of excess fluid pressure, to prevent damage or accidents.

In particular, a spring-loaded valve is known to be used, including a spring designed to cause the valve to open when a pressure threshold is reached.

The spring may or may not be manually adjustable.

In the case of manual adjustment, an operator constantly stresses the spring via a thumbwheel, which is not practical for the operator.

In the absence of manual adjustment, the valve is tripped at a fixed pressure. For example, if the pressure threshold for tripping is 240 bar, while the fluid is at 80 bar during operation, for the intended use at that time, the difference between reaching the triggering threshold is 160 bar. This difference may be very high, and, for example, reach the pump's maximum operating pressure. This could result in damage to the pump and/or an accident.

### SUMMARY OF THE INVENTION

The aim of the invention is therefore to offer a hydraulic circuit with an adjustable valve that does not require constant maintenance by an operator.

To this end, the invention relates to a hydraulic circuit of the aforementioned type, wherein the valve separates the valve chamber into a first sub-chamber and a second sub-chamber, each sub-chamber having a volume that varies depending on the displacement of the valve, the first sub-chamber having a first inlet connected to a tapping point of the circuit section, the second sub-chamber having a second inlet, the second inlet being adapted to be connected to an air connection of the air motor, the valve being translated according to the pressure at the first inlet and the pressure at the second inlet.

In this way, the tripping of the valve depends on the pressure of the fluid in the hydraulic circuit and the air pressure in the drive, once the second inlet has been connected. The valve is thus controlled pneumatically, via the motor air, so that the valve trip setting is adjusted based on the driving of the pump, i.e., the operation of the pump as controlled by the motor. This does not require the intervention of an operator. In the event of excess pressure, for example when a coating product spray is stopped in the previous example, the valve moves from the operating position to the relief position.

In other beneficial aspects of the invention, the circuit includes one or more of the following features, taken in isolation or in any technically possible combination:
the valve is in or moves to the operating position when the pressure at the first inlet is strictly lower than the pressure at the second inlet by a multiplicative factor, the valve being such that it is in or moves to the relief position when the pressure at the first inlet is strictly greater than the pressure at the second inlet by a multiplicative factor;
the multiplicative factor is equal to the ratio of the area of the valve surface facing the second inlet in the operating position of the valve to the area of the valve surface facing the first inlet in the operating position of the valve;
the valve includes a needle, the needle closing the first inlet in the operating position of the valve, the needle extending at a distance from the first inlet in the relief position of the valve;
the valve chamber has at least one discharge opening, the at least one discharge opening being arranged in the first sub-chamber in the valve relief position;
the discharge opening is connected to an auxiliary fluid circuit, the fluid in the auxiliary fluid circuit having a pressure strictly lower than the pressure of the fluid in the circuit section;
the valve includes a piston separating the valve chamber into a first sub-chamber and a second sub-chamber;
the piston is provided with a seal, the seal being arranged to improve sealing between the piston and the valve chamber;
the piston and needle are fixed in relation to each other and integral to any movement of the valve; and
the second inlet is fitted with a non-return valve.

The invention also relates to a pump including a hydraulic circuit of the aforementioned type, an air motor driving the fluid of the circuit section of the hydraulic circuit, and an air connection linking an air outlet of the air motor and the second inlet.

### BRIEF DESCRIPTION OF THE DRAWINGS

The invention will appear more clearly when reading the description that follows, given solely as a non-limiting example and made in reference to drawings in which:

FIG. 1 is a cross-sectional view of part of an example pump according to one embodiment of the invention; and

FIG. 2 is a cross-sectional view of the pump in FIG. 1 along a plane II.

### DETAILED DESCRIPTION

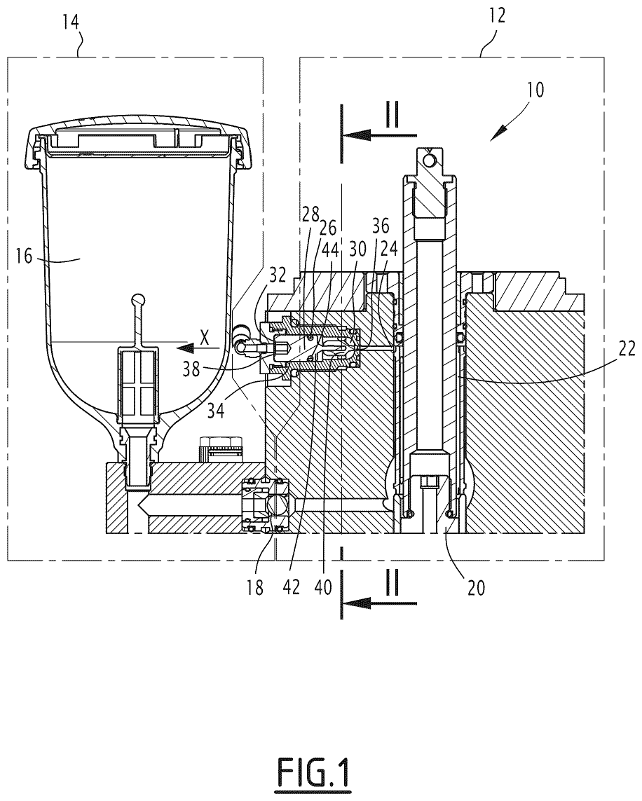

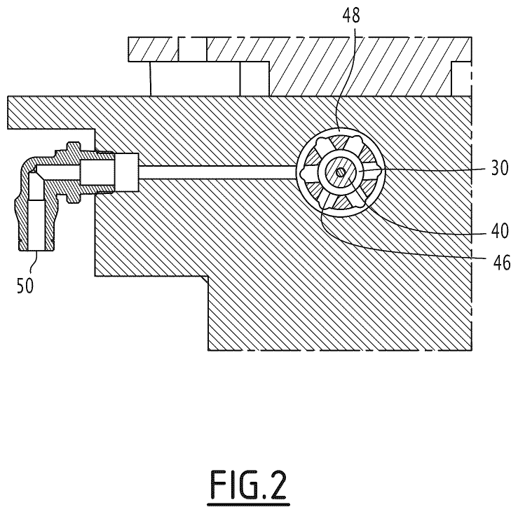

A pump according to one embodiment of the invention is shown in part in FIGS. 1 and 2.

The pump is used, for example, to supply coating product to a coating product spraying device. The spraying device includes, for example, at least one spray gun.

The pump includes a hydraulic circuit 10, an example of which is partially visible in FIGS. 1 and 2, an air motor and an air connection.

Hydraulic circuit 10 includes a circuit section, the circuit section containing a fluid, for example oil.

The air motor drives the fluid in the circuit section of hydraulic circuit 10.

The air motor has an air outlet.

The air motor is such that the air at the air outlet has a pressure equal to the pressure of the air driving the hydraulic circuit, more precisely the circuit section.

The air pressure is, for example, between 0.5 and 7 bar.

The air connection connects the air outlet of the air motor and the second inlet of the hydraulic circuit, described below.

The invention further relates to hydraulic circuit 10 as such.

The hydraulic circuit includes, for example, a high-pressure section 12 and a low-pressure section 14.

High-pressure section 12 corresponds to the circuit section defined above.

More specifically, the motor drives the fluid in high-pressure section 12, for example via a piston 20.

High-pressure section 12 and low-pressure section 14 contain the same fluid.

In high-pressure section 12, the pressure of the fluid in the hydraulic circuit is strictly higher than the pressure of the fluid in low-pressure section 14. For example, in high-pressure section 12, the hydraulic circuit fluid may reach a pressure of 280 bar at 7 bar air pressure, while in low-pressure section 14, the hydraulic circuit fluid has a pressure of 0.5 bar.

The fluid in high-pressure section 12 has a pressure of between 20 and 280 bar, for example.

During normal operation of the pump, the pressure of the fluid in high-pressure section 12 is equal to the pressure of the air driving the fluid multiplied by a pump constant, i.e.:

$${P}_{f\_ hp} = kp \times {P}_{a i r} ,$$

where P_{f_hp} is the pressure of the fluid in high pressure section 12, kp is the pump constant, and Pair is the air pressure of the motor driving the fluid.

The pump constant kp is between 1.1 and 1.3, preferably 1.3.

Low-pressure section 14 and high-pressure section 12 are fluidically connected to each other via an interface 18. Typically, interface 18 includes a non-return valve allowing flow from the low-pressure section to the high-pressure section.

Low-pressure section 14 includes, for example, a fluid reservoir 16, for example a fluid cup.

Fluid reservoir 16 acts as a fluid expansion tank in low-pressure section 14.

Fluid reservoir 16 is adapted to supply the rest of the hydraulic circuit with fluid if required. In particular, if necessary, fluid reservoir 16 is adapted to supply the rest of low-pressure section 14 with fluid, so as to supply high-pressure section 12.

Fluid reservoir 16 is adapted so that excess fluid in low-pressure section 14 is redirected to fluid reservoir 16.

High-pressure section 12 includes, for example, a pipe 22, the pipe being filled with fluid.

Piston 20 is able to move in pipe 22 to drive the fluid into high-pressure section 12.

Hydraulic circuit 10 includes a tapping point 24, more particularly in high-pressure section 12, more particularly in pipe 22.

The fluid taken off at the tapping point has the same pressure as in high-pressure section 16.

Hydraulic circuit 10 includes a valve chamber 26, in which a valve 28 is arranged.

Valve 28 separates valve chamber 26 into a first sub-chamber 30 and a second sub-chamber 32.

The valve may be moved in translation in valve chamber 26 between an operating position and a relief position (shown in FIG. 1).

The valve may be moved in translation in a direction of translation X.

Valve chamber 26 extends around an axis extending in direction of translation X.

Valve chamber 26, for example, is rotationally symmetrical around the axis.

Valve chamber 26 includes a cylindrical portion 34 around the axis.

First sub-chamber 30 and second sub-chamber 32 extend opposite each other from valve chamber 26 in direction of translation X.

The volume of each sub-chamber 30, 32 varies as the valve moves.

The volume of first sub-chamber 30 in the operating position is strictly less than the volume of first sub-chamber 30 in the relief position.

First sub-chamber 30 has a first inlet 36 connected to tapping point 24.

Second sub-chamber 32 has a second inlet 38, the second inlet being adapted to be connected to an air connection of the air motor.

In the embodiment shown, in the relief position, the volume of second sub-chamber 32 is substantially zero, valve 28 extending against an end face of the valve chamber, more particularly the end face delimiting the second inlet.

Second inlet 38 is, for example, advantageously provided with a non-return valve.

This non-return valve prevents any backflow of fluid instead of air via the air connection in the event of a leak between first sub-chamber 30 and second sub-chamber 32.

First inlet 36 and second inlet 38 are arranged opposite each other in valve chamber 26, more particularly in direction of translation X.

Valve 28 is translated within valve chamber 26 as a function of pressure at first inlet 36, more specifically the fluid at first inlet 36, and pressure at second inlet 38, more specifically of the air at second inlet 38.

More particularly, valve 28 is in the operating position when pressure at first inlet 36 is strictly less than pressure at second inlet 38 by a multiplicative factor, valve 28 being such that it moves to the relief position when pressure at first inlet 36 is strictly greater than pressure at second inlet 38 by the multiplicative factor.

The multiplicative factor is a fixed number.

The multiplicative factor is specific to the valve and the valve chamber.

Valve 28 is in the operating position or moves towards the operating position when the following inequality is satisfied:

$${P}_{36} < k \times {P}_{38} ,$$

where P₃₆ is pressure at first inlet 36, P₃₈ is pressure at second inlet 38, and k is the multiplicative factor.

Valve 28 is in the relief position or moves towards the relief position when the following inequality is met:

$${P}_{36} > k \times {P}_{38} .$$

Multiplicative factor k is equal to the ratio of the area of the surface of valve 28 facing second inlet 38 in the operating position of the valve to the area of the surface of valve 28 facing first inlet 36 in the operating position of the valve.

Multiplicative factor k is strictly greater than the pump constant.

The ratio of multiplicative factor k to the pump constant is between 1.1 and 1.3.

In the example shown, valve 28 includes a needle 40 and a piston 42.

Here, valve 28 consists of needle 40 and piston 42.

Needle 40 and piston 42 are arranged one after the other in direction of translation X.

Needle 40 and piston 42 are fixed relative to each other and are, in particular, integral in any movement of the valve, particularly in translation along direction of translation X.

Needle 40 is arranged opposite first inlet 36.

Needle 40 is arranged in first sub-chamber 30.

Needle 40 closes first inlet 36 in the operating position of valve 28, needle 40 extending at a distance from first inlet 36 in the relief position of valve 28.

Needle 40 is not in contact with any wall of valve chamber 26, other than at first inlet 36 in the operating position.

The surface of the valve facing first inlet 36 in the operating position corresponds here to an end surface of needle 40.

The end surface of needle 40 defines the end of needle 40 in the direction of translation facing first inlet 36.

The end surface of needle 40 here defines the end of needle 40 opposite piston 42.

The end surface of needle 40 closes first inlet 36 in the operating position.

In the example shown, the end surface of needle 40 penetrates into first inlet 36 in the operating position, so as to seal it off.

The area of the end surface of needle 40 is equal to the area of the passage surface of first inlet 36.

Alternatively, valve chamber 26 defines a seat for the needle at the first inlet. In the operating position, needle 40 extends against the seat so as to close off the first inlet. In the relief position, needle 40 extends at a distance from the seat.

Piston 42 separates valve chamber 26 into first sub-chamber 30 and second sub-chamber 32 in a sealed manner.

Piston 42 includes a cylindrical part around the axis of valve chamber 26.

The cylindrical part of piston 42 is movable in cylindrical portion 34.

An outer wall of the cylindrical part is arranged against an inner wall of the valve chamber delimiting cylindrical portion 34.

Cylindrical portion 34 includes the second sub-chamber and the location of the cylindrical part of piston 42 in the operating position.

Piston 42 is, for example, advantageously provided with a seal 44.

Seal 44 is designed to improve sealing between piston 42 and chamber 26, i.e., between first sub-chamber 30 and second sub-chamber 32.

Seal 44 is, for example, an O-ring arranged on a circumference of piston 42.

Seal 44 is, for example, arranged in a recess in the outer wall of the cylindrical part, opposite the inner wall defining cylindrical portion 34.

The surface of valve 28 facing second inlet 38 in the operating position corresponds here to an end surface of piston 42.

The end surface of piston 42 defines the end of piston 42 in direction of translation X facing second inlet 38.

The end surface of piston 42 here defines the end of piston 42 opposite needle 40.

Valve chamber 26 has at least one discharge opening 46.

The at least one discharge opening 46 is arranged in first sub-chamber 30 in the valve relief position.

More particularly here, the at least one discharge opening 46 is arranged in chamber 26, so that it is always arranged in first sub-chamber 30, regardless of the position of the valve in valve chamber 26.

Valve chamber 26 here has a plurality of discharge openings distributed around its circumference, here at regular intervals.

The or each discharge opening 46 is connected to an auxiliary fluid circuit, corresponding here to low-pressure section 14.

More particularly, the or each discharge opening 46 is connected to low-pressure section 14 outside of bucket 16.

More specifically, discharge openings 46 connect valve chamber 26 to a single circulation ring 48.

Circulation ring 48 is a cavity surrounding valve chamber 26 at discharge openings 46.

Circulation ring 48 is connected to the auxiliary fluid circuit, in particular via a connection 50.

The or each discharge opening 46 extends perpendicularly to direction of translation X.

Valve chamber 26 here is closed off outside first inlet 36, second inlet 38 and the at least one discharge opening 46.

A method for operating a hydraulic circuit or pump according to the invention will now be described with reference to the figures.

In normal operation, the air motor drives the hydraulic circuit according to the air pressure in the motor.

The pressure at the second inlet to the valve chamber is equal to the air pressure of the motor.

The pressure of the fluid in the circuit section is less than a displacement pressure of the valve, which is a function of the pressure at the second inlet, more particularly here equal to the pressure at the second inlet by the multiplicative factor.

The fluid pressure in the circuit section is equal to the air pressure of the motor multiplied by the pump constant.

At this pressure, the valve is in the operating position.

The fluid is not released through the valve.

In the event of a malfunction resulting in excess pressure, the fluid pressure in the circuit section increases until it exceeds the displacement pressure of the valve.

The valve then moves to the relief position.

The fluid in the circuit section is then released via the valve chamber, more particularly via the at least one discharge opening.

The released fluid is released to the auxiliary fluid circuit.

Fluid is released until the pressure of the fluid in the circuit section drops below the displacement pressure of the valve, which is a function of the pressure at the second inlet.

When the pressure of the fluid in the circuit section, and therefore at the first inlet, is lower than the displacement pressure of the valve, the valve moves back into its operating position.

This stops the release of fluid.

The displacement of the valve has therefore enabled excess pressure to be managed, the pressure value considered to be excess pressure being a function of the value of the pressure at the second inlet, in this case the air pressure of the motor for the drive.

In this way, the adjustment of such a value is pneumatically controlled, by the motor air, to be set in accordance with nominal operation of the pump.

In an alternative embodiment not shown, the at least one discharge opening 46 is arranged in valve chamber 26, so that it opens into first sub-chamber 30 in the relief position, but does not open into first sub-chamber 30 or second sub-chamber 32 in the operating position.

The valve operates as described above. In particular, the valve may be moved in translation as described above.

For example, the valve includes a piston as described above, with the at least one discharge opening opposite the piston in the operating position. The piston then includes, for example, O-rings arranged on either side of the circumference where the at least one discharge opening opens out.

In the alternative embodiment, the valve does not, for example, block the first inlet in the operating position. In this way, the first inlet is always fluidically connected to the first sub-chamber.

In the operating position, with the valve blocking the at least one discharge opening, fluid cannot escape from the first sub-chamber.

In the relief position, with the valve freeing the at least one discharge opening, the fluid is released from the first sub-chamber through the at least one discharge opening.

Such a valve operates in a similar way to the method described above. In the event of excess pressure, this causes the valve to move to the relief position, so that the valve releases the at least one discharge opening, and fluid is released from the first sub-chamber via the at least one discharge opening.

The hydraulic circuit and the pump according to the invention therefore enable excess pressure to be released via the valve, this excess pressure being considered in relation to the air pressure of the drive, once the second inlet has been connected. This way, the valve trip setting is adjusted directly based on the driving of the pump, i.e., the operation of the motor-controlled pump.

1. A hydraulic circuit of a hydraulic pump with an air motor, the hydraulic circuit comprising:
a circuit section, the circuit section containing a fluid, the hydraulic circuit being adapted so that the fluid in the circuit section is driven by the air motor of the hydraulic pump;
a valve chamber; and
a valve, the valve being arranged in said valve chamber, the valve being movable in translation in said valve chamber between an operating position and a relief position, wherein the valve divides said valve chamber into a first sub-chamber and a second sub-chamber, each of the first and second sub-chambers comprising a variable volume depending on movement of the valve, the first sub-chamber comprising a first inlet connected to a tapping point of said circuit section, the second sub-chamber comprising a second inlet, the second inlet being adapted to be connected to an air connection of the air motor, the valve being driven in translation according to pressure at the first inlet and pressure at the second inlet.

2. The hydraulic circuit according to claim 1, wherein said valve is in or moves into the operating position when pressure at said first inlet is strictly less than pressure at said second inlet by a multiplicative factor, said valve being such that it is in or moves into the relief position when pressure at said first inlet is strictly greater than pressure at said second inlet by the multiplicative factor.

3. The hydraulic circuit according to claim 2, wherein the multiplicative factor is equal to the ratio of the area of the surface of said valve facing said second inlet in the operating position of said valve to the area of the surface of said valve facing said first inlet in the operating position of said valve.

4. The hydraulic circuit according to claim 3, wherein said valve comprises a piston separating said valve chamber into said first sub-chamber and said second sub-chamber, and wherein said piston and said needle are fixed relative to each other and integral with each other for any movement of said valve.

5. The hydraulic circuit according to claim 1, wherein said valve comprises a needle, the needle blocking said first inlet in the operating position of said valve, the needle extending at a distance from said first inlet in the relief position of said valve.

6. The hydraulic circuit according to claim 1, wherein said valve chamber comprises at least one discharge opening, the at least one discharge opening being arranged in said first sub-chamber in the relief position of said valve.

7. The hydraulic circuit according to claim 6, wherein said at least one discharge opening is connected to an auxiliary fluid circuit, the fluid of the auxiliary fluid circuit having pressure strictly lower than pressure of the fluid in said circuit section.

8. The hydraulic circuit according to claim 1, wherein said valve comprises a piston separating said valve chamber into said first sub-chamber and said second sub-chamber.

9. The hydraulic circuit as claimed in claim 8, wherein said piston is provided with a seal, the seal being arranged to improve sealing between said piston and said valve chamber.

10. The hydraulic circuit according to claim 1, wherein said second inlet is provided with a non-return valve.

11. The hydraulic circuit according to claim 1, wherein the fluid is oil.

12. A pump comprising:
a hydraulic circuit according to claim 1;
an air motor driving the fluid of the circuit section of said hydraulic circuit; and
an air connection connecting an air outlet of said air motor and the second inlet of said hydraulic circuit.
